(19) United States
(12) Patent Application Publication
(10) Pub. No.: US 2021/0269991 A1
(43) Pub. Date: Sep. 2, 2021

(54) WORKING MACHINE MOVABLE ON A SUBSTRATE

(71) Applicant: Hamm AG, Tirschenreuth (DE)

(72) Inventors: Detlef BORNEMANN, Leonberg (DE); Werner VÖLKEL, Neustadt (DE); Hermann GRADL, Tirschenreuth (DE); Markus SCHEDL, Püchersreuth (DE)

(21) Appl. No.: 17/186,592

(22) Filed: Feb. 26, 2021

(30) Foreign Application Priority Data
Mar. 2, 2020 (DE) 10 2020 105 479.3

(51) Int. Cl. E01C 19/26; E01C 19/23

(52) U.S. Cl. CPC E01C 19/26; E01C 19/238

(57) ABSTRACT

A working machine, movable on a substrate, comprises a sensor arrangement, wherein the sensor arrangement comprises:
at least one sensor housing (24) with a sensor accommodation space (26) open via a detecting aperture (30),
at least one sensor (28) arranged in the sensor accommodation space (26) of the at least one sensor housing (24),
at least one air-supply arrangement (32) for generating an air flow (L) flowing through the sensor accommodation space (26) in the at least one sensor housing (24).

The present invention relates to a working machine, for example, a soil compactor for compacting asphalt, which is movable on a substrate while carrying out an operation.

When carrying out these types of operations, it is advantageous or necessary to provide information about surroundings parameters, for example, the temperature of the asphalt to be compacted by a soil compactor. To provide this type of information, one or more suitable sensors may be provided on a working machine to detect the relevant parameters, for example, the temperature of the asphalt to be compacted.

It is the object of the present invention to provide a working machine, which is movable on a substrate, and for which the relevant information may be precisely provided for carrying out an operation.

According to the present invention, this problem is solved by a working machine, which is movable on a substrate, and comprises a sensor arrangement, wherein the sensor arrangement comprises:
at least one sensor housing with a sensor accommodation space open via a detecting aperture,
at least one sensor arranged in the sensor accommodation space of the at least one sensor housing,
at least one air-supply arrangement for generating an air flow flowing through the sensor accommodation space in the at least one sensor housing.

By generating an air flow which flows through the space in which a sensor is arranged, it is ensured that contaminants may not accumulate in this space, that is, the sensor accommodation space. Contaminants, for example, dust particles, raindrops, or the like, are carried out of the sensor accommodation space by the air flow, so that the detection accuracy or the functionality of a sensor arranged in this sensor accommodation space is not impaired by particles depositing in the sensor accommodation space or on the sensor.

In order to generate the air flow, the at least one air supply arrangement may comprise:
a compressor,
   or
a ventilator,
   or
a fan.

In order to ensure that the air conveyed by the at least one air supply arrangement into the sensor accommodation space does not contain any particles impairing the functionality of a sensor, an air filter may be assigned to an intake area of the at least one air supply arrangement.

Since the risk of intrusion by contaminants into the sensor accommodation space exists particularly in the area of the detecting aperture, thus, that opening, through which the sensor, arranged in this type of sensor accommodation space, may pass to interact with the surroundings to be detected by the same, it is further proposed that at least one part of the air flow flowing through the sensor accommodation space, preferably the entirely of the air flow flowing through the sensor accommodation space, exits the sensor accommodation space via the detecting aperture. It may thus be efficiently ensured that contaminants may not penetrate into the sensor accommodation space via the detecting aperture or that contaminating particles may already be blown away out of spatial area in front of the detecting aperture.

The repelling of contaminating particles from a sensor may be further supported in that the at least one sensor arranged in the sensor accommodation space may be at least partially flowed around by the air flow.

In order to also prevent the penetration by particles into a sensor accommodation space, even when the working machine is not operating, a closure flap for closing the detecting aperture may be assigned to the at least one sensor housing.

It is thereby proposed, for a structurally simple configuration, that the closure flap is pre-biased into a closed position closing the detecting aperture, and is displaceable by the air flow into an open position releasing the detecting aperture, wherein the closure flap may be pre-biased into the closed position by a pre-biasing element, preferably a pre-biasing spring, for example, a leg spring, and/or by gravity.

In particular in the case that the working machine is a soil compactor for compacting asphalt, it is advantageous if at least one sensor is a temperature sensor, as the temperature of the asphalt to be compacted is a relevant parameter for the type of compacting process to be carried out.

The working machine may be designed, for example, as:
a soil processing machine, for example, a soil compactor, rotary tiller, or an asphalt paving machine,
an agricultural machine, for example, a tractor, combine, or mulcher.

The present invention is subsequently described in detail with reference to the appended figures. As shown in:

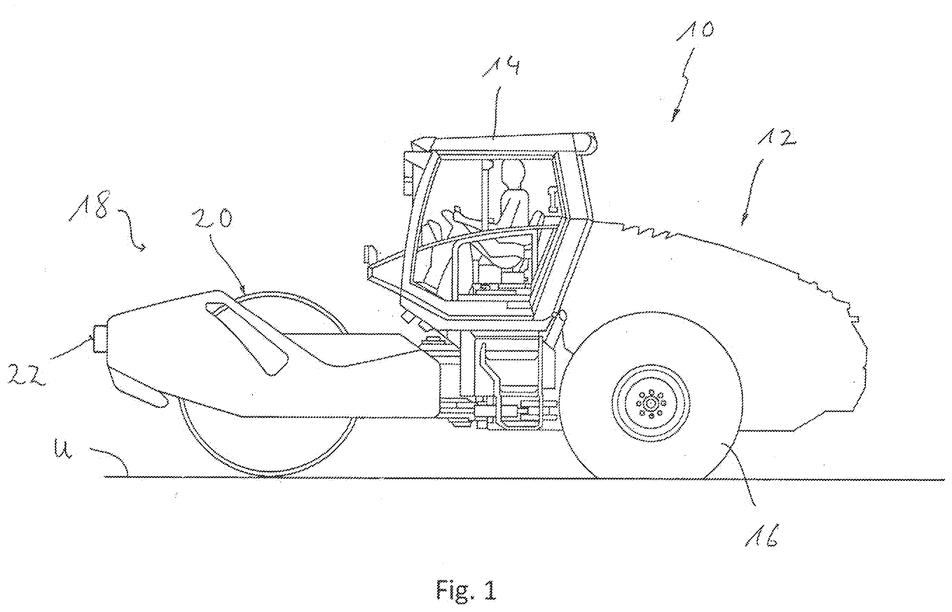

FIG. 1 a working machine designed as a self-propelled soil compactor;

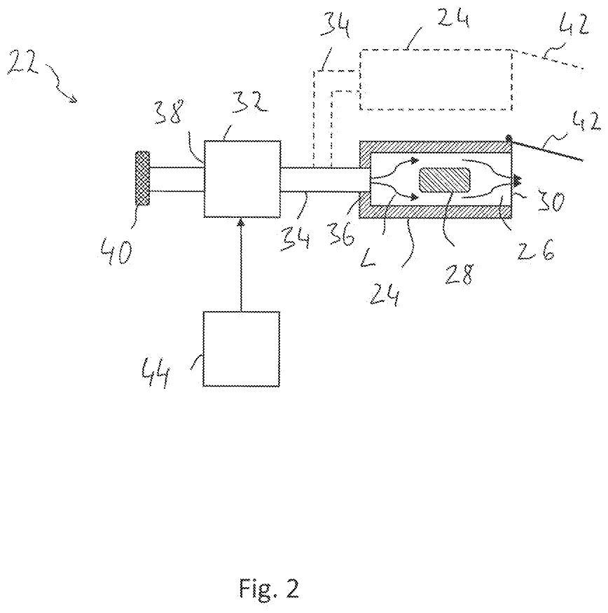

FIG. 2 a sensor arrangement for a working machine in a fundamental representation.

A working machine, movable on a substrate U, in the form of a self-propelled soil compactor 10 is depicted in FIG. 1. Soil compactor 10 comprises a rear section 12, on which a drive assembly, an operator booth 14, and driven wheels 16 are provided. A compacting roller 20, with which substrate U is compacted by soil compactor 10 driving over the same, is provided on a front section 18 pivotably connected to rear section 12. Reference is made to the fact that a soil compactor 10 of this type may be designed in the most varied of ways. Thus, for example, a compacting roller 20 may also be provided on rear section 12. Furthermore, this type of soil compactor may have on the rear section, for example, a plurality of wheels arranged adjacent to each other and acting as a whole as a compacting roller.

A sensor arrangement, generally designated with 22, is provided on the soil compactor. This sensor arrangement 22, depicted in detail in FIG. 2, comprises one or more sensor housing/s 24 with a sensor accommodation space 26 designed therein. At least one sensor 28 is arranged in sensor accommodation space 26 of each sensor accommodation housing 24. Sensor accommodation space 26 is open to the surroundings via a detecting aperture 30 formed on sensor housing 24, so that sensor 28 arranged in sensor accommodation space 26 may pass through via detecting aperture 30 to interact with the surroundings to be detected or sampled by the same.

For example, the or at least one of sensors 28 may be configured as a temperature sensor, which detects the temperature of substrate U in front of soil compactor 10. In addition, sensor 28 may be designed, for example, as an optical sensor, in particular as an infrared sensor, and the temperature information provided by the same may be routed to an evaluation unit (not depicted in the figures), in which this temperature information is evaluated and taken into account, for example, when carrying out a soil compacting process.

An airflow L, which may be supplied to the or each sensor housing 24 via an air supply duct 34, is generated by an air supply arrangement 32 designed, for example as a compressor, ventilator, or fan. Alternatively, air supply arrangement 32 may also be structurally linked to at least one sensor housing 24, and may introduce air flow L directly into sensor accommodation space 26 formed in this sensor housing 24.

The introduction of air flow L is carried out preferably in the area of rear wall 36 of sensor housing 24 opposite detecting aperture 30. Air flow L, introduced in sensor accommodation space 26, flows around sensor 28 positioned in sensor accommodation space 26 and thus carries contaminating particles accumulating in the area of sensor 28 or in sensor accommodation space 26 out of sensor accommodation space 26 or prevents that contaminating particles present in front of detecting aperture 30 may penetrate into sensor accommodation space 26.

In order to prevent contaminating particles being introduced into sensor housing(s) 24 with air flow L generated by air supply arrangement 32, an air filter 40 may be assigned to an intake area 38 of air supply arrangement 32.

FIG. 2 further shows that a closure flap 42 is assigned to at least one, preferably each sensor housing 24. This may be pivotably supported on sensor housing 24 and may be pre-biased into a closed position closing detecting aperture 30 of this sensor housing 24. In the positioning depicted in FIG. 2, in which sensor housing 24 is positioned substantially horizontally or detecting aperture 30 is arranged extending substantially vertically, gravity acting on closure flap 42 may be used to pre-bias closure flap 42 into the closed position, when said closure flap is pivotably mounted on sensor housing 24 in an area above detecting aperture 30. Alternatively or additionally, a pre-biasing element, e.g., a pre-biasing spring, for example, a leg spring, may be provided, by means of which closure flap 42 is pre-biased into its closed position. The use of this type of pre-biasing element is then particularly advantageous when sensor housing 24 is arranged with a detecting aperture 30 oriented downward or obliquely downward, for example, in order to sample the substrate in the area of a working machine, for example, of soil compactor 10 depicted in FIG. 1.

To displace closure flap 42 into the open position, depicted in FIG. 2, in which detecting aperture 30 is released, and thus sensor 28 may pass through said detecting aperture to interact with the surroundings to be detected by the same, air flow L, generated by air supply arrangement 32 is used, in order to generate a force, based on the accumulation pressure generated in the area of detecting aperture 30, to pivot closure flap 42 from its closed position into the open position depicted in FIG. 2. It is thus guaranteed that whenever air supply arrangement 32 is not activated to generate air flow L, closure flap 42 automatically arrives at its closed position and thus prevents the penetration of contaminants into assigned sensor accommodation space 26.

Air supply arrangement 32 may be controlled by a control unit 44. This may additionally be designed to then activate air supply arrangement 32 to generate air flow L when the drive assembly is activated, for example, a diesel internal combustion engine provided on rear section 12. Alternatively, it may be provided that air supply arrangement 32 is then activated by control unit 44 when a vibration arrangement or oscillation arrangement provided in compacting roller 20 is activated, as this is an indicator that soil compactor 10 is beginning to compact substrate U. Alternatively or additionally, a switch may also be provided, for example in the area of operating booth 14, by means of which an operator controlling soil compactor 10 may manually activate or also deactivate air supply arrangement 32.

Reference is finally made to the fact that sensor arrangement 22 may be varied in very different aspects. Thus, for example, this type of sensor housing 24 may be arranged distributed on a working machine in different areas, in order to create the possibility of sampling the surroundings around the working machine depending on different working directions. If multiple sensor housings 24 are provided, these may be supplied by a mutual air supply arrangement 32, as is indicated in FIG. 2. It is alternatively possible to also provide different air supply arrangements 32 and/or valve arrangements assigned to different sensor housings 24, in order to generate, for example, an air flow L only assigned to one or the other sensor housings 24 whose sensors 28 are supposed to be active when carrying out a working process. Multiple sensors 28 may also be arranged, for example, in one sensor housing 24, and different sensor housings 24 may be configured structurally differently from each other or be equipped with different types of sensors 28, e.g., temperature sensors, air pressure sensors, humidity sensors, or the like, and also with different numbers of sensors. Furthermore, multiple sensor accommodation spaces 26 may be provided in one sensor housing 24, wherein each of these sensor accommodation spaces 26 may contain one or more sensors 28, for example, sensors of different types. A closure flap 42 may be assigned in each case to one or more of these sensor accommodation spaces 26 or to respective detecting aperture 30.

1. Working machine, movable on a substrate, comprising a sensor arrangement, wherein the sensor arrangement comprises:
at least one sensor housing with a sensor accommodation space open via a detecting aperture,
at least one sensor arranged in the sensor accommodation space of the at least one sensor housing, and
at least one air-supply arrangement for generating an air flow flowing through the sensor accommodation space in the at least one sensor housing.

2. Working machine according to claim 1, wherein the at least one air supply arrangement comprises:
a compressor,
or
a ventilator,
or
a fan.

3. Working machine according to claim 1, wherein an air filter is assigned to an intake area of the at least one air supply arrangement.

4. Working machine according to claim 1,
wherein at least one part of the air flow flowing through the sensor accommodation space leaves the sensor accommodation space via the detecting aperture.

5. Working machine according to claim 1,
wherein the at least one sensor arranged in the sensor accommodation space is at least partially flowed around by the air flow.

6. Working machine according to claim 1,
wherein a closure flap is assigned to the at least one sensor housing for closing the detecting aperture.

7. Working machine according to claim 6,
wherein the closure flap is pre-biased into a closed position closing the detecting aperture and is movable by the air flow into an open position releasing the detecting aperture.

8. Working machine according to claim 7,
wherein the closure flap is pre-biased into the closed position by a pre-biasing element and/or by gravity.

9. Working machine according to claim 1,
wherein at least one sensor is a temperature sensor.

10. Working machine according to claim 1,
wherein the working machine is configured as:
a soil processing machine, for example, a soil compactor, rotary tiller, or an asphalt paving machine,
an agricultural machine, for example, a tractor, combine, or mulcher.

11. Working machine according to claim 4,
wherein the entire air flow flowing through the sensor accommodation space leaves the sensor accommodation space via the detecting aperture.

12. Working machine according to claim 8,
wherein the pre-biasing element is a pre-biasing spring.
